(19) United States
(12) Patent Application Publication
(10) Pub. No.: US 2011/0273525 A1
(43) Pub. Date: Nov. 10, 2011

(54) METHOD FOR CHANGING FOCUS POSITION OF A LENS

(76) Inventors: Israel Schuster, Kiryat-Tivon (IL); Yehuda Solomon, Rishon Lezion (IL)

(21) Appl. No.: 12/774,017

(22) Filed: May 5, 2010

(51) Int. Cl. B41J 2/47; G02B 7/04

(52) U.S. Cl. 347/225; 359/820

(57) ABSTRACT

A method for changing a focus position of an imaging lens (116) includes monitoring a temperature of the imaging lens. The position of the imaging lens is adjusted to compensate for temperature changes.

### CROSS REFERENCE TO RELATED APPLICATIONS

Reference is made to commonly-assigned copending U.S. patent application Ser. No. ______ (Attorney Docket No. 96250/NAB), filed herewith, entitled AN APPARATUS FOR COMPENSATING AN IMAGING LENS, by Israel Schuster, the disclosure of which is incorporated herein.

### FIELD OF THE INVENTION

This present invention relates to an imaging head for a laser processing system and more specifically to adjusting an imaging lens component within an imaging head.

### BACKGROUND OF THE INVENTION

Laser imaging system 100, shown in FIG. 1, typically includes a light source 108 which emits light which is focused on an imaging media 124. The light passes through imaging lens 116, and is focused on specific areas of the surface of the imaging media 124. The imaging lens 116 may comprise a single lens element or may be a compound imaging lens 116 comprising a plurality of lens elements.

Although the glass components forming imaging lens 116 are transparent, the light absorption by the lens is not zero. In cases where the light source 108 is a laser and emits high energy, the energy absorption in imaging lens 116 is significant, and it increases the temperature of the glass components, creating a thermal gradient within the imaging lens components. This temperature variation causes a change in the optical behavior due to variations in size, shape, and index of refraction. Each one of these changes or a combination of them may cause a shift in the image position, yielding a shift in imaging lens 116 focus. The change in focus introduces image artifacts on the imaged imaging media 124.

### SUMMARY OF THE INVENTION

Briefly, according to one aspect of the present invention a method for changing a focus position of an imaging lens includes monitoring a temperature of the imaging lens. The position of the imaging lens is adjusted to compensate for temperature changes.

The invention and its objects and advantages will become more apparent in the detailed description of the preferred embodiment presented below.

### BRIEF DESCRIPTION OF THE DRAWINGS

FIG. 1 is a schematic showing a prior art laser processing system;

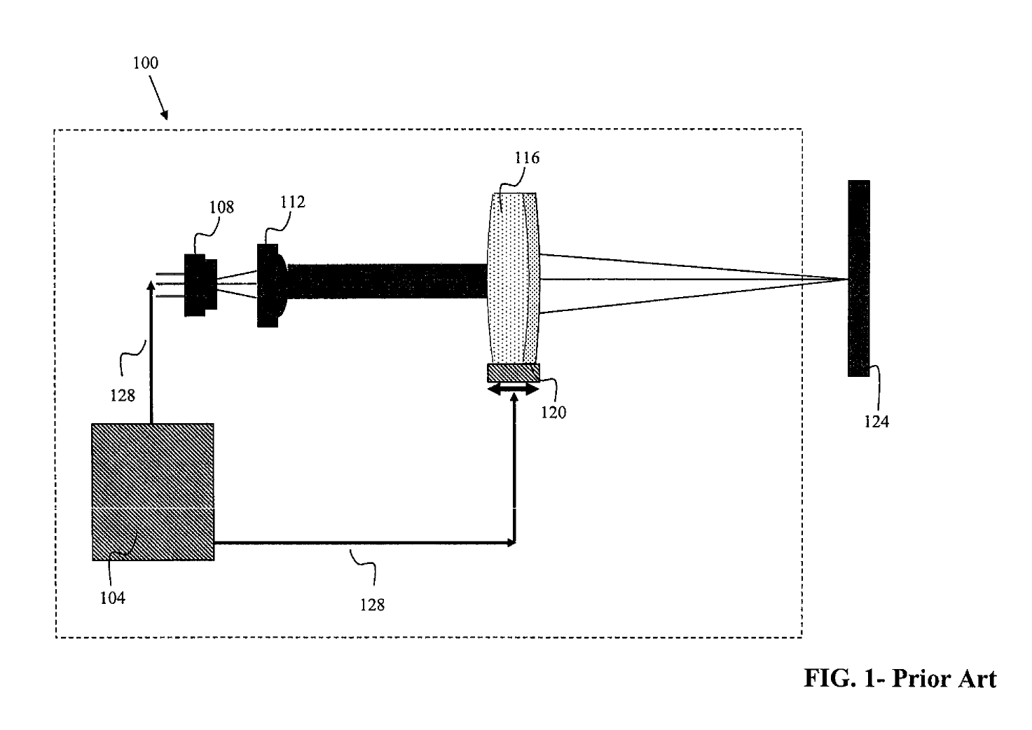

FIG. 2 is a schematic showing a prior art computer-to-plate (CTP) system for reference;

FIG. 3 is a schematic of a prior art laser diode array;

FIG. 4 is a schematic of a lens imaging system adjusted to compensate for thermal readings from the lens; and

FIG. 5 is a schematic of a lens imaging system adjusted to compensate for thermal readings from the lens in a CTP environment.

### DETAILED DESCRIPTION OF THE INVENTION

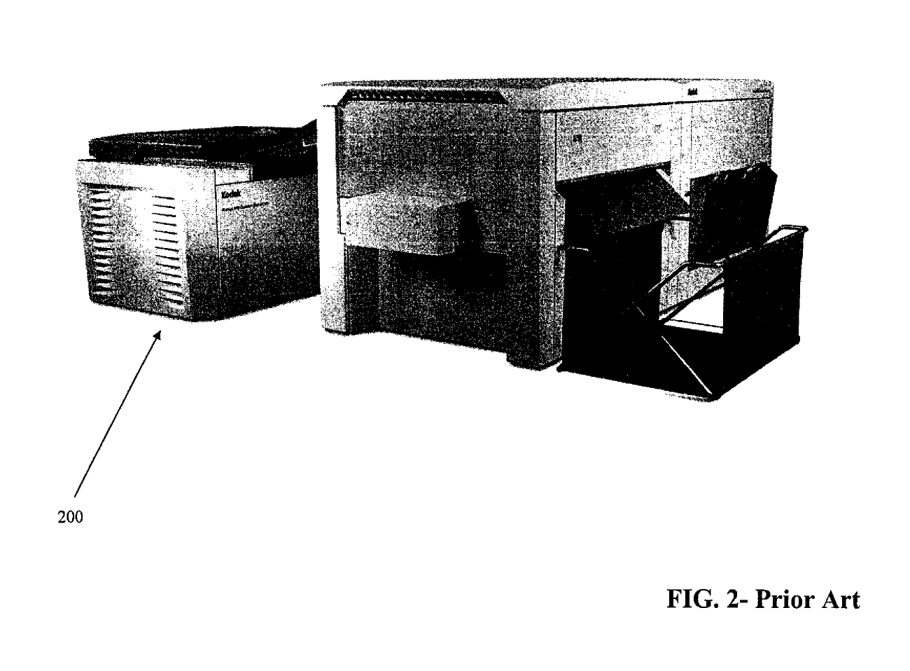

The present invention describes an adjustment apparatus and method for an imaging lens component operated in an imaging head of a laser processing system of a CTP imaging device 200 shown in FIG. 2.

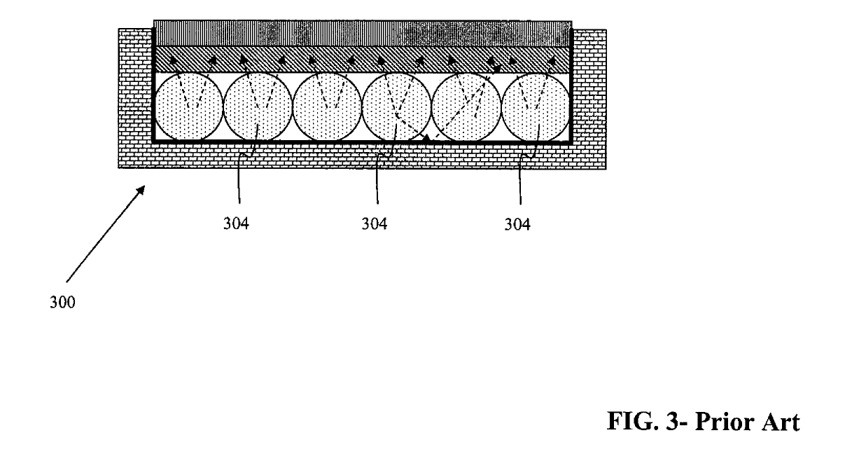

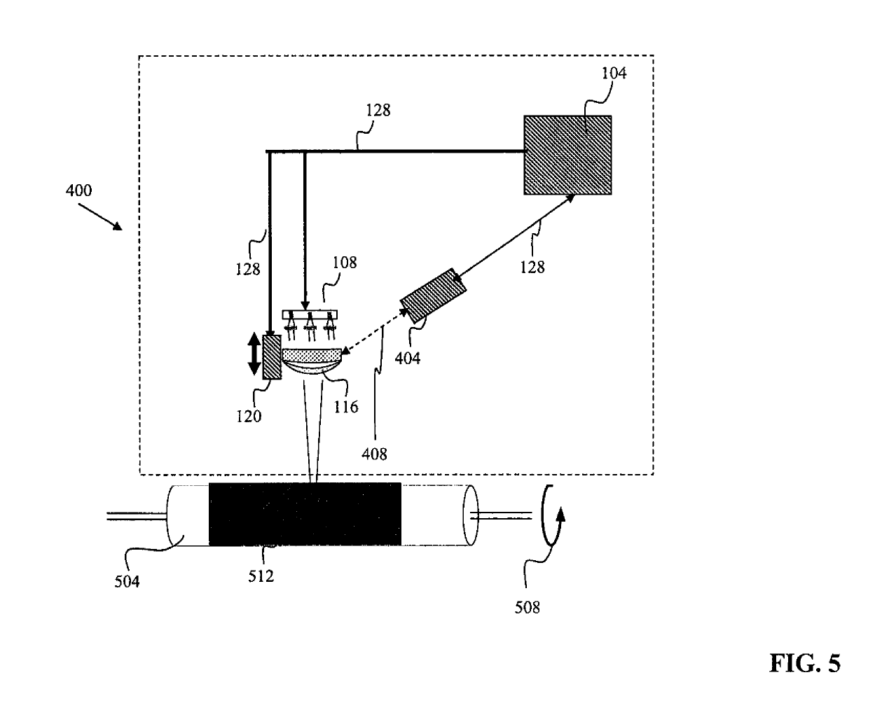

FIG. 2 shows a computer-to-plate (CTP) imaging device 200 equipped with a laser imaging system. The imaging device 200 is adapted to image printing plates 512 (shown in FIG. 5). The CTP imaging device employs high power imaging sources such as array of laser diodes 300 as shown in FIG. 3. The array is constructed from a plurality of fiber coupled laser diodes 304 that may emit as much as 1 kW and more.

In addition to CTP imaging devices, the present invention may be used in any machine designed for laser assisted material processing. It can also be used in any optical setup that is expected to operate in variable temperatures. The variable temperature can be either due to external factors or due to its operation.

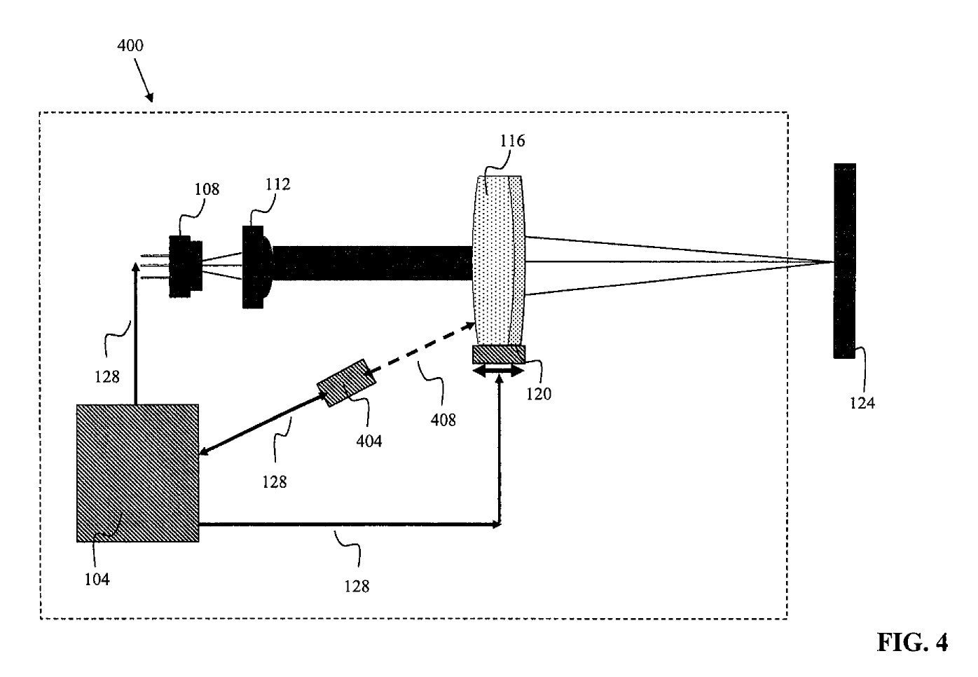

FIG. 4 shows an imaging system 400. In operation, controller 104 supplies data to be imaged on imaging media 124 to an imaging light source 108, typically built from an array of laser diodes 300. Light source 108 is adapted to image on imaging media 124 via a lens system (112, 116). When the light is transmitted through a lens (112, 116), although the glass components are transparent, the light absorption is not zero.

Due to the high power transmitted by the imaging device through the imaging lens 116, the energy absorption is significant and increases the temperature of the glass components, creating a thermal gradient within the imaging lens components. This temperature variation causes a change in the optical behavior due to variations in size, shape, and index of refraction. Each one of these changes or a combination of them may cause a shift in the image position, yielding a shift in imaging lens 116 focus. The change in focus might introduce image artifacts on the imaged imaging media 124.

The present invention prevents or at least minimizes such artifacts. A thermal sensor 404 monitors the surface of at least one of the glass elements of imaging lens 116. By measuring the temperature of the surface, controller 104 receives the temperature readings via control lines 128 from thermal sensor 404. Controller 104 calibrates the readings to compensate for focus shift, and thus signals imaging lens adjustment element 120 thought control lines 128 to compensate for the thermal focus shift by moving the position of imaging lens 116, or part of it, with respect to the optical path.

The preferred embodiment of this invention used a non-contact thermal sensor such as thermal sensor 404 shown in FIG. 4. Thermal sensor 404 detects infrared emission 408 from imaging lens 116. The levels of the detected infrared emission 408 generated from imaging lens 116 indicates the temperature in proximity to imaging lens 116. Another embodiment attaches a contact temperature sensing element to imaging lens 116.

FIG. 5 shows a laser processing system 400 in a CTP imaging device 200. A printing plate 512, which is mounted on a rotating drum 504, is imaged with imaging light source 108 through imaging lens 116. Drum 504 rotation direction 508 is in the direction shown. Compensation for temperature changes in the lens is the same as described above.

The invention has been described in detail with particular reference to certain preferred embodiments thereof, but it will be understood that variations and modifications can be effected within the scope of the invention.

### PARTS LIST

100 laser imaging system (laser processing system)
104 controller
108 light source
112 collimation lens
116 imaging lens
120 imaging lens adjustment element
124 imaging media
128 control lines
200 computer-to-plate (CTP) system
300 array of laser diodes
304 laser diodes in array 200
400 imaging system with thermal adjustable imaging lens
404 thermal sensor
408 infrared emission
504 CTP drum
508 drum rotation direction
512 printing plate

1. A method for changing focus position of an imaging lens comprising:
monitoring a temperature of said imaging lens u; and
adjusting the position of said imaging lens to compensate for temperature changes.

2. An imaging system for a computer to plate device comprising:
a light source;
an imaging lens for focusing said light source on a plate;
a temperature sensor for monitoring a temperature of said imaging lens;
an imaging lens adjustment element for adjusting a focus position of said imaging lens to maintain a beam from said light source in focus on said plate; and
a controller for processing temperature readings and adjusting the position of said imaging lens by activating said imaging lens adjustment element.
